(19) United States
(12) Patent Application Publication
(10) Pub. No.: US 2025/0334946 A1
(43) Pub. Date: Oct. 30, 2025

(54) Application Module for a Control Device

(71) Applicant: Siemens Aktiengesellschaft, Muenchen (DE)

(72) Inventors: Ingo THON, Grasbrunn (DE); Josep SOLER GARRIDO, Sevilla (ES); Alexander KESSLER, Nürnberg (DE); Frank ROELOFS, Lauf (DE)

(21) Appl. No.: 18/865,002

(22) PCT Filed: Apr. 17, 2023
(86) PCT No.: PCT/EP2023/059875

§ 371 Date: Nov. 12, 2024

(30) Foreign Application Priority Data
May 13, 2022 (EP) 22173350

(51) Int. Cl. G05B 19/05; G05B 23/02

(52) U.S. Cl. CPC G05B 19/058; G05B 23/0256

(57) ABSTRACT

An application module for a control device, wherein the application module is configured to communicate and interact with further components of the control device as part of the control of a machine or system, where the application module is configured to generate an additional functionality for the control device through the use of a user application, where an automation engineering system is provided for establishing the control device and an application engineering system is provided for creating the user application, and where the application module is configured such that testing of the user application occurs or can be performed via an interaction of the application module with the application engineering system.

### CROSS-REFERENCE TO RELATED APPLICATIONS

This is a U.S. national stage of application No. PCT/EP2023/059875 filed 17 Apr. 2023. Priority is claimed on European Application No. 22173350.4 filed 13 May 2022, the content of which is incorporated herein by reference in its entirety.

### BACKGROUND OF THE INVENTION

### 1. Field of the Invention

The present invention relates to an application module for a control device, where the application module is configured to communicate and interact with further components of the control device in the context of control of a machine or installation, and where the application module is configured to generate additional functionality for the control device via a user application.

### 2. Description of the Related Art

Application modules are generally known from the prior art.

In this regard, e.g., European patent EP 2 325 708 B1 discloses a real-time runtime system comprising a plurality of function modules and a management module. The plurality of function modules are configured to log on at the management module during a transition state between initialization and pre-operation with an allocated module identification and to log off during a transition state between pre-operation and initialization. At least one of the plurality of function modules is configured to set up communication connections to further function modules during the transition state between pre-operation and test operation via the management module, to break down the communication connections during the transition state between test operation and pre-operation, to log on at the further function modules during the transition state between test operation and real-time operation and to log off during the transition state between real-time operation and test operation.

One disadvantage of the prior art is that control programs or other applications for control devices are developed and thoroughly tested in the respective development systems for these programs (e.g., an “automation engineering system”), and, therefore, when they are executed on corresponding control hardware, problems may occur owing to the fact that on account of, e.g., specialties in the control hardware used, the execution of the program in the development system runs differently than when the program is executed on the control hardware itself.

### SUMMARY OF THE INVENTION

In view of the foregoing, it is therefore an object of the present invention to provide an improved method and a corresponding apparatus that enable improved and/or simplified testing of software or applications for control systems.

This and other objects and advantages are achieved in accordance with the invention by an application module that is configured for use in a control device, where the application module is configured to communicate and interact with further components of the control device in the context of control of a machine or installation.

The application module is furthermore configured to generate additional functionality for the control device via a user application. Here, the application module is configured to execute an operating mode, where during the operating mode the additional functionality for the control device is generated using the user application.

Furthermore, the application module is configured to execute a test mode, where the test mode is configured for testing the user application.

The fact that the application module has a test mode in accordance with the present disclosure, or is configured to execute such a test mode, enables improved and/or simplified testing of software or applications for the application module or a control system comprising such an application module.

Such a test mode makes it possible, for example, that the application module itself, and thus the hardware on which the user application is ultimately intended to run, is already used for testing the user application. It is thus possible to reduce or even avoid problems and faults that may occur because the execution of the user application on a development system for such user application and on the control device or the application module may be different, because different hardware equipment of both systems may lead to different program executions.

Such a test mode can be configured, for example, such that a user application can be tested or is testable in the application module in the context of such a test mode. Here, the test mode can be configured such that when a user application is executed in the context of such a test mode, no control commands are output to a machine or installation controlled by the corresponding control device.

The application module can be configured, for example, as a hardware module. Such a hardware module can be configured, for example, as a structurally independent module. Such a structurally independent hardware module can, for example, have a housing and/or comprise mechanical elements or apparatuses for coupling to the control device or for mechanical integration into the control device.

Furthermore, the application module can be communicatively connected or connectable to the control device and/or further components of the control device. In a further embodiment, the application module can be communicatively releasably connected or connectable to the control device and/or further components of the control device.

Furthermore, the application module can be configured as a software module. Here, for example, a control device can comprise this software module and the control device can furthermore be configured to execute this application module formed as a software module.

In one advantageous embodiment, the application module forms part of the control device. here, the application module can be logically associated with the control device, for example. Furthermore, the application module can be mechanically and/or communicatively coupled to the control device or mechanically and/or communicatively integrated into the control device. The application module can also be configured as a software application, where the control device can then comprise the application module formed as a software application.

An application module can be configured as a freely programmable application module. A freely programmable application module makes it possible to provide a freely programmable or independently programmable “application” or “app” which is executed as part of firmware of the application module and/or is executed in the context of an execution environment provided by the application module.

A freely programmable application module can be configured, for example, to execute software or programs that are created and executed in a programming language that is not supported by one or more further components and/or modules of the control device or the remaining components and/or modules of the control device. In particular, a freely programmable application module can be configured, for example, to execute software or programs that are created and/or executed in a programming language that is not defined by the International Electrotechnical Commission (IEC) standard 61131 or comparable standards regarding control devices and/or programmable logic controllers as programming languages for such devices.

In one advantageous embodiment, a freely programmable application module is not configured to execute programs that are or have been created in a programming language as per IEC 61131, IEC 61499 or a comparable standard. These are. e.g.. the programming languages: instruction list (IL), ladder diagram (LD), function block diagram (FBD), sequential function chart (SFC) and structured text (ST).

A freely programmable application module for a control device can be configured, for example, in such that it is configured to execute a software application in addition to a control program, executed in the control device, for controlling the machine or installation. Such a freely programmable application module makes it possible to realize a functionality of the control device in addition to a standard control functionality that is realized, for example, by a central control module for the control device. The central control module can be configured, for example, to execute the control program for controlling the machine or installation. The central control module can, for example, also be configured as per the standard IEC 61131, IEC 61499 and/or comparable standards or comprise at least one functionality of this type.

Examples of such application modules may be, for example, hardware and/or software modules for executing machine learning applications. Further examples of such application modules, are for example, hardware and/or software modules for realizing Boolean processors, for realizing or performing simulations or the execution of simulation programs, for programming or executing mathematical algorithms, analytical methods or big data analyses, for executing independent programs in one or more predefined programming languages (e.g., C, C++, Python, . . . ) or hardware and/or software modules for comparable uses or applications.

The control device can be configured, e.g., as an electronic device for controlling an apparatus or installation. It can be configured, e.g., as a programmable logic controller, a modular programmable logic controller, a computer with a control software application or control app, a “soft PLC”, or else only a control software application. Furthermore, a control device can also be configured as computer hardware, a computer and/or IT network or a cloud with control software installed, implemented and/or instantiated thereon. Here, the control software can also be of modular construction and consist of a plurality of software modules.

In this case, a control device can be configured in modular manner such that a plurality of modules are or can be provided, where one or more expansion modules can be provided besides a “central module” or CPU module configured to execute a control program, e.g., to control a component, machine or installation (or a part thereof). Such expansion modules can be configured, for example, as a current/voltage supply or else for inputting and/or outputting signals from or to a machine or installation, or furthermore also as a function module for undertaking specific tasks (e.g., a counter, a converter, data processing using artificial intelligence methods (comprising, e.g., a neural network or some other ML model) . . . ).

The control device can furthermore also be configured as an EDGE device, where such an EDGE device can comprise, for example, an application for controlling apparatuses or installations. For example, such an application can be configured as an application having the functionality of a programmable logic controller. Here, the EDGE device can be connected, for example, to a further control device of an apparatus or installation, or else directly to an apparatus or installation to be controlled. Furthermore, the EDGE device can be configured such that it is additionally also connected to a data network or a cloud or is configured for connection to a corresponding data network or a corresponding cloud. An example of an EDGE device is the SIMATIC IPC847E Industrial Edge Device, manufactured by Siemens. A key feature of such an edge device is a processor (CPU, e.g., Intel Xeon E 2278GE) and memory. Other EDGE devices are the SIMATIC IPC127E, the SIMATIC IPC227E and the SIMATIC IPC427E, which all include a processor (CPU) and memory.

The control device can, for example, also be configured as a programmable logic controller (PLC). Furthermore, the safety-oriented control device can also be configured and formed as a modular programmable logic controller (modular PLC).

A programmable logic controller, PLC for short, is a component that is programmed and used to control an installation or machine by closed-loop or open-loop control. Specific functions such as sequence control, for example, can be implemented in programmable logic controllers, such that both the input signals and the output signals of processes or machines can be controlled in this way. Fundamental properties of a programmable logic controller are defined for example in the standard EN 61131, IEC 61131 and/or EN 61499. The programmable logic controller can be configured, e.g., as per at least one of the standards EN 61131, IEC 61131 and/or EN 61499 and/or at least one of the partial standards of the standards EN 61131, IEC 61131 and/or EN 61499.

A PLC can be realized in various ways. That is, it can be implemented as an individual electronic device, as software emulation, as a PC plug-in card, etc. Modular solutions are often also found in the context of which the PLC is assembled from a plurality of plug-in modules.

For controlling the machine or installation, the control device can comprise, for example, corresponding interfaces and/or modules for communication with the machine or installation.

The control device can be configured, for example, for real-time control of the machine or installation.

For communication with further components of the control device, the application module can comprise, for example, a corresponding interface for operating a communication connection to the further components of the control device. Here, such communication can occur, for example, via a corresponding internal bus, an external bus or a combination of an internal and external bus. Here, the aforementioned buses can be configured, for example, at least inter alia for real-time communication between the different components of the control device.

In the case of a modular control device comprising a plurality of modules that is formed as hardware, such communication with further components of the control device can take place via a “backplane bus”, for example. In the case of a control device comprising a plurality of software modules that is realized within a computing device, a computer or an industrial PC, such communication can occur via a corresponding internal bus, for example. Here, the internal bus can be configured, for example, at least inter alia for real-time communication between different components of the control device.

An additional functionality for a control device may be, for example, a functionality for such a control device that is not made available by a central control component and/or other components of the control device. For example, an additional functionality for a control device can be configured as a functionality that is not predefined by a standard for control devices, for example, the standard IEC 61131, IEC 61499 or comparable standards. Additional functionalities for a control device may be or may comprise, for example, one or more of the functionalities listed below: a functionality for executing software in a specific programming language, a functionality for implementing mathematical algorithms, analysis methods and/or big data analytics, a functionality for realizing and/or implementing machine learning methods, machine learning models, artificial intelligence procedures and methods, neural networks or the like, a functionality for realizing Boolean methods, or comparable functionalities.

A user application may also be referred to as a user program and in this case may be any kind of software that configured and/or provided for execution within the application module, for configuring and/or parameterizing the application module, for use by the application module and/or for storage within the application module. Furthermore, a user application may be any kind of software that is executed on the application module and using which the application module is or was configured and/or parameterized and that is or was used by the application module and/or that is stored in the application module, in particular in a storage device of the application module. Here, a user application can comprise, for example, an executable software program and/or data or parameters for use by the application module and/or the user application.

Here, software is understood to mean, for example, programs and the associated documentation and further data that are necessary for operating a computer. This is defined in this way in the International Organization for Standardization/International Electrotechnical Commission (ISO/IEC) Standard 24765, for example.

The additional functionality for the control device can then be realized, for example, by the execution of a corresponding user application or of a corresponding user program in the application module, the execution of software already implemented in the application module and/or of a corresponding operating system (firmware) using corresponding user data or parameters, or otherwise a combination of these options.

In the operating mode, the application module makes available the additional functionality for the control device.

In one advantageous embodiment, the application module makes the additional functionality for the control device in the operating mode available, while the application module is linked into the control device or interacts with further components of the control device in the context of the control of the machine or installation.

Furthermore, the application module can comprise operating system software that is configured such that the application module is operable both in the operating mode and in a test mode or that the application module is operated in an operating mode or a test mode.

Here, the application module can be configured such that, for example, after the application module has been switched on and/or started up, the application module goes into the operating mode, unless corresponding parameters, triggers, signals, user inputs or comparable data or components that initiate an alternative procedure are present. Such an alternative procedure may be, for example, the starting of a test mode for testing a user application, an update mode for updating an installed application, an operating system or firmware of the application module, or starting of comparable alternative modes.

The test mode can be configured, for example, in such that activities of the application module that are executed in the context of the test mode do not have effects on machines or installations possibly controlled by the control device and/or the application module. In this way, for example, it is possible to test a user application in the application module without, for example, faults in the user application being accompanied by the possible occurrence of disturbances and/or damage in other components of the automation system into which the application module is linked. In particular, in this way, when testing the user application, it is not possible for disturbances and/or damage to arise in a control device into which the application module is linked, or in a correspondingly connected and/or controlled machine or installation.

The test mode thus makes it possible to test user applications in configurable scenarios directly on the application module, i.e., with the module hardware that is also used later.

The application module can go or switch into the test mode, for example, if corresponding parameters, triggers, signals, user inputs or comparable data or components are present and are recognized or detected by the application module.

Such recognition and/or detection of corresponding parameters, triggers, signals, user inputs or other pieces of information that initiate a test mode can be initiated, for example, by specific operating states or changes in operating states, such as starting up, initializing or starting or restarting of the application module. Furthermore, the test mode can also be initiated by separate interrogations. Such interrogations can be initiated, for example, by a user input (e.g., a key on the application module or otherwise a corresponding input via a device attached or connected to the application module, such as a computer, a human machine interface (HMI), a cellphone, and/or a tablet). Furthermore, such interrogations can also be automatically performed once or otherwise regularly by the application module.

Here, the application module can furthermore be configured such that the application module is configured to perform the test mode even if it is not connected or coupled to a corresponding control device. In this way, it is possible to test a user application for the application module, even actually in the absence of the complete control hardware or the complete control device with which, in a later application, the application module interacts for controlling a machine or installation.

Furthermore, the application module can also be configured such that the application module is configured to perform the test mode when it is connected or coupled to the control device.

In one advantageous embodiment, the application module can be structured such that it is configured to perform the test mode both when it is connected or coupled to the control device and when it is not connected or coupled to the control device.

Here, as already explained above, the coupling or being connected to the control device is understood to mean at least a communicative coupling or connection.

Testing the user application is understood to mean, for example, that the user application is executed and/or implemented in a way in which it will also be executed when the user application interacts with further components of the control device for controlling a machine or installation.

In particular, the testing of the user application can be configured such that, during the testing of the user application, although the user application is executed in the application module or implemented there in the same way as later during the control of a machine or installation, no control signals whatsoever are output to the machine or installation during the testing.

During the testing of the user application, configurations, parameterizations and/or execution code of the user application can thus be tested in configurable scenarios.

The objects and advantages are also achieved in accordance with the invention by an application module for a control device, where the application module is configured to communicate and interact with further components of the control device in the context of control of a machine or installation, where the application module is configured to generate additional functionality for the control device via a user application, and where furthermore the application module is configured such that the user application is testable on the application module, even if the application module is not connected to the control device or further components of the control device.

In one advantageous embodiment, the application module can be configured such that the user application is testable on the application module, even if the application module is at least communicatively not connected to the control device.

In one advantageous embodiment, an automation engineering system configures the control device and an application engineering system creates the user application, where the application module is configured such that testing of the user application occurs or can be performed via interaction of the application module with the application engineering system.

Here, the application module can furthermore be configured such that testing of the user application occurs or can be performed via direct interaction of the application module with the application engineering system.

In a further advantageous embodiment, an automation engineering system configures the control device and an application engineering system creates the user application, where the application module is configured such that testing of the user application occurs or can be performed without inclusion of the control device and/or the automation engineering system.

The presently contemplated embodiment makes it possible to test a user application on the application module, without the automation engineering system having to be involved or used in the process. It is thus also possible to test the user application on the application module directly in conjunction with the application engineering system, and without the automation engineering system also having to be included.

The presently contemplated embodiment makes it possible, for example, for the application engineering system, which is also used for designing, developing, creating and/or parameterizing the user application, also to be used for testing the user application on the application module. Therefore, apart from the specific application know-how for the testing of the user application, there is a need for relatively little, or even no, information or experience regarding further components of the control device, in particular no knowledge regarding a corresponding automation engineering system.

This is advantageous in particular for user applications that require specific know-how or specific knowledge, such as in the field of machine learning, artificial intelligence, neural networks, simulations, big data analysis, statistics, mathematical algorithms, specific programming languages or comparable applications. This is owing to the fact, for example, that in general a person skilled in the art for this specific know-how does not necessarily also have corresponding know-how in dealing with a corresponding automation engineering system or creating control programs and/or when configuring a control device.

Simplified and/or improved testing of software or applications for control systems is thus made possible in this way.

Here, an automation engineering system is understood to mean a system or software used for programming, parameterizing and/or configuring control devices for controlling machines or installations. In particular, for example, an automation engineering system is used to create corresponding control programs for a control device, to configure corresponding communication connections for communication within the control device and/or for communication with corresponding computers, computer networks or a cloud, HMI devices, other control devices, edge devices, field devices, drives and/or sensors, and also to configure and/or parameterize the control device itself. In the case of a control device comprising a plurality of components, for example, the individual components are configured and/or parameterized and also the connection thereof is configured and parameterized via a corresponding automation engineering system.

An automation engineering system can be configured, for example, as a computer system with suitable software, the computer system being configured to generate automation engineering data for a specific machine or production installation. Such automation engineering data are, for example, data such as are created and/or provided for the automation and/or control of the production installation or machine. This includes, for example, the fact that, for example, corresponding control programs are created and the components of the production installation or machine and also of the corresponding controls are correspondingly parameterized via such an automation engineering system. One example of such an engineering system is a computer system upon which the commercially available software having the product name “TIA Portal” is installed.

Here, automation engineering data can comprise a wide variety of engineering elements, for example, one or more control programs, variables, “tags”, program blocks, function blocks, data blocks, program units, so-called “program organizational units”, used data types, ID information concerning components, configuration data, call information for program elements, comments, control programs and/or comparable engineering elements.

An application engineering system can be configured, for example, as software installed on a computer, a computer network or in a cloud, where the software is configured for developing a user application in accordance with the presently disclosed embodiments.

In particular, an application engineering system can be configured for creating user applications in a specific technical field or user applications of a specific type. Application engineering systems can be configured, for example, for creating user applications in the field of machine learning, artificial intelligence, neural networks, simulations, big data analysis, analytics, statistics, mathematical algorithms, specific programming languages (e.g., C, C++, or Python) and/or in comparable fields.

The fact that testing of the user application occurs or can be performed via interaction or direct interaction of the application module with the application engineering system can be configured, for example, such that a corresponding automation engineering system for the control device is not involved in such testing.

In this way, for example, the development tools that were used when developing the user application or are made available by the application engineering system can also be used in the testing of the user application, or at least participate in the testing of the user application.

Direct interaction is understood here to mean, for example, that no further logical unit is involved in the context of the interaction between the application engineering system and the application module. The direct interaction can, for example, also be configured such that, in the context of the interaction between the application engineering system and the application module, there is no significant data conversion or no data conversion in the context of transfer of data between the application engineering system and the application module.

The fact that the application module directly interacts with the application engineering system does not mean that there must be an uninterrupted communication connection, a direct communication connection or a communication connection at all between the application engineering system and the application module.

In the context of the testing, there is no need for a communication connection or a permanent communication connection between the application engineering system and the application module. The testing can be configured, for example, such that, for example, data preparation or application preparation for the testing is executed by the application engineering system and these data or this user application are/is then transferred to the application module for the purpose of testing. The transfer can occur, for example, via a communication connection or else a mobile storage device (for example, an SD card or the like) or similar manner.

The application engineering system can also be communicatively connected to the application module during the testing. Here, the testing of the user application can proceed on the application module, for example, without the participation of the application engineering system or with the participation of the application engineering system.

The objects and advantages are also achieved in accordance with the invention by an application module for a control device, where the application module is configured to communicate and interact with further components of the control device in the context of control of a machine or installation, where the application module is configured to generate additional functionality for the control device via a user application, where an automation engineering system for configuring the control device and an application engineering system for creating the user application are provided, and where the application module is configured such that testing of the user application occurs or can be performed via interaction of the application module with the application engineering system.

Here, the application module can furthermore be configured such that testing of the user application occurs or can be performed via direct interaction of the application module with the application engineering system.

Here, the interaction or the direct interaction of the application module with the application engineering system can be configured such that the testing of the user application occurs or can be performed without inclusion of the control device and/or the automation engineering system.

The objects and advantages are also achieved in accordance with the invention by an application module for a control device, where the application module is configured to communicate and interact with further components of the control device in the context of control of a machine or installation, where the application module is configured to generate additional functionality for the control device by means of the use of a user application, where an automation engineering system for configuring the control device and an application engineering system for creating the user application are provided, and where the application module is configured such that testing of the user application occurs or can be performed without inclusion of the control device and/or the automation engineering system.

Here, the application module, the control device, the communication and/or the interaction of the application module with further components of the control device, the further components of the control device, the control of the machine or installation, the additional functionality for the control device, the user application, the automation engineering system, the application engineering system, the testing of the user application and the direct interaction of the application module with the application engineering system can be configured in accordance with the presently disclosed embodiments.

Such an application module makes it possible, for example, for the application engineering system, which is also used for designing, developing, creating and/or parameterizing the user application, also to be used for testing the user application on the application module. Therefore, apart from the specific application know-how for the testing of the user application, there is a need for relatively little, or even no, information or experience regarding further components of the control device, in particular no knowledge regarding a corresponding automation engineering system.

Simplified and/or improved testing of software or applications for control systems is thus made possible in this way. Here, the application module can be configured for executing an operating mode, wherein in the operating mode the additional functionality for the control device is generated using the user application. The application module can furthermore be configured for executing a test mode, where the test mode is configured for testing the user application.

Such a test mode makes it possible, for example, that the application module, and thus the hardware on which the user application is ultimately intended to run, is used or can be used already for testing the user application. It is thus possible, e.g., already to recognize problems and/or faults which are caused, for example, by differences in the hardware (and/or properties of the hardware) between the application module and the system upon which the user application was developed.

The fact that the application module has a test mode in accordance with the disclosed embodiments, or is configured for executing such a test mode, enables improved and/or simplified testing of software or applications for the application module or a control system comprising such an application module.

Here, for example, the application module, the operating mode, the additional functionality, the control device, the user application and the test mode can be configured in accordance with the presently disclosed embodiments.

An application module in accordance with the disclosed embodiments can furthermore be configured such that the application module comprises a control device simulation application for simulating a control functionality of the control device.

This embodiment has the advantage that by way of the simulation application, the application module itself is enabled, for example, in the context of the testing of a user application, to make available or implement functionalities that are made available by one or more other components of the control device in the normal work sequence of the control device. This improves and/or simplifies testing of a user application with the application module because in this way, during the testing of a user application, the application module is less dependent on other components of the control device, or is even independent of other components of the control device.

In one advantageous embodiment, the application module can furthermore be configured for simulating a fundamental control functionality of the control device or a basic control functionality of the control device.

Here, a fundamental control functionality of the control device can be configured, for example, as a functionality as defined, e.g., for programmable logic controllers, for example, in one or more of the standards EN 61131, IEC 61131, EN 61499, IEC 61499. Furthermore, a fundamental control functionality or basic control functionality can comprise, for example, those functionalities that are defined in one or more of the standards EN 61131, IEC 61131, EN 61499, IEC 61499 and that are executed or can be executed by a control device, a programmable logic controller or a central or CPU module of a modular programmable logic controller.

The application module can also furthermore comprise a simulation of one or more external interfaces (e.g., external interfaces of the control device) (e.g., an Ethernet interface and/or an Ethernet port for an external camera, e.g., a GigE Vision camera) or otherwise simulations of further components (e.g., further components of the control device or else external components (e.g., of a camera simulation)).

The simulation of a control functionality of the control device can comprise, e.g., a simulation of a firmware functionality of the control device.

Furthermore, the simulation of a control functionality of the control device can also be configured as a control device simulation program.

The simulation of a control functionality of the control device can, for example, also be configured as a simulation of a fundamental control functionality of the control device.

Furthermore, a fundamental control functionality can also be configured as that functionality that is, must and/or can be made available to the application module by other components of the control device in the context of the execution of the user application. A fundamental control functionality may thus be the functionality that must and/or can be made available to the application module by one or more other components of the control device in the context of an intended execution of the user application in the application module.

Such other components of the control device may be, for example, a central processing unit, or a central module or CPU module, of the control device or else, for example, an input and/or output module, a function module and/or an interface module (e.g., a fieldbus interface module, an Ethernet interface module, an Open Platform Communications Unified Architecture. (OPC UA) interface module or comparable interface modules).

An exemplary functionality of a simulation application for simulating a control functionality of the control device is described below. In this example, the application module is configured for executing a neural network application. In this example, the user application is configured for realizing an automatic optical inspection (AOI) using a neural network. Here, it comprises the execution of the automatic optical inspection and all necessary information about the neural network. The latter may be, for example, the parameters of the nodes of the neural network and a number and/or layer arrangement of these nodes, or otherwise may be a corresponding program code (e.g., in the “Python” language) for realizing the neural network.

Here, the simulation of the control functionality then comprises for example one, a plurality or all of the functionalities mentioned below:
the simulation of a trigger for starting an image evaluation by the application module with an automatic optical inspection (AOI) user application;
providing an image if an image is requested by the application module or the AOI user application;
providing a second image if this is requested by the application module or the AOI user application;
collecting the results after processing of the data by the neural network;
transferring the abovementioned results to a target medium.

Here, the target medium may be, for example, a storage device in the application module, a releasable connectable storage device in the application module (e.g., a memory card) or otherwise an external computing device;
comparing the results of the processing of the data by the neural network with predefined desired or target results;
transferring the results of the abovementioned comparison of the results with the desired or target results to a target medium. Here, the target medium may be, for example, once again a storage device in the application module, a releasably connectable storage device in the application module or else an external computing device or an external computing network.

The objects and advantages are also achieved in accordance with the invention by an application module for a control device, where the application module is configured to communicate and interact with further components of the control device in the context of control of a machine or installation, where the application module is configured to generate additional functionality for the control device by means of the use of a user application, and where the application module comprises a control device simulation application for simulating a control functionality of the control device.

An application module structured in this way has the advantage that via the simulation application, the application module itself is, for example, enabled, in the context of the testing of a user application, to make available or implement functionalities that are made available by other components of the control device in the normal work sequence of the control device. This improves and/or simplifies testing of a user application with the application module since in this way, during the testing of a user application, the application module is less dependent on other components of the control device, or is even independent of other components of the control device.

In this case, the application module, the control device, the communication and the interaction of the application module with further components of the control device, the further components of the control device, the control of the machine or installation, the additional functionality for the control device, the user application, the control device simulation application and the simulation of a control functionality of the control device can be configured in accordance with the disclosed embodiments.

Furthermore, an automation engineering system for configuring the control device and an application engineering system for creating the user application can be provided, where the application module is configured such that testing of the user application occurs or can be performed via interaction of the application module with the application engineering system.

Here, the application module can furthermore be configured such that testing of the user application occurs or can be performed via direct interaction of the application module with the application engineering system.

Here, the application module, the automation engineering system, the control device, the application engineering system, the user application, the testing of the user application and the interaction or the direct interaction of the application module with the application engineering system can be configured in accordance with the disclosed embodiments.

Furthermore, the application module can be configured for executing an operating mode, where during the operating mode the additional functionality for the control device is generated using the user application, and where furthermore the application module is configured for executing a test mode, and where the test mode is configured for testing the user application.

Here, the application module, the operating mode, the additional functionality for the control device, the user application, the test mode and the testing of the user application can be configured in accordance with the disclosed embodiments.

In one advantageous embodiment, a test identifier is provided, where the application module is furthermore configured for interrogating and/or recognizing the test identifier and for executing the test mode after recognition of the test identifier. Furthermore or alternatively, the application module can also be configured for testing the user application after recognition of the test identifier.

The presence of such a test identifier makes it possible to initiate testing of a user application with the application module as necessary. This furthermore improves and/or simplifies testing of the user application.

The configuring and/or storing of such a test identifier can be performed, for example, by a user or semi-automatically or automatically, for example, by an application engineering system for creating the user application.

In this case, the test identifier may be any suitable, for example, digital and/or electronically storable variable or any digital datum that can be storable in a storage device. By way of example, the test identifier can be stored or is storable in a storage device of the application module, for example, also a storage device releasably connectable to the application module (e.g., an SD card or the like). Furthermore, the test identifier may also be an electromechanical or mechanical identifier, for example, the pressing of a pushbutton, the actuating of a switching device or a comparable mechanical or electromechanical identifier.

The interrogation of the test identifier can comprise, for example, the interrogation of a corresponding variable or of a corresponding storage location in a storage device or else the interrogation, for example, of the position or a state of an electromechanical or mechanical identifier. The recognition of the test identifier comprises the knowledge of the application module regarding which stored value or which state of an electromechanical or mechanical identifier initiates or results in testing of the user application or execution of a corresponding test mode.

Here, interrogation of the test identifier by the application module can occur at one predefined point in time, a plurality of predefined points in time (e.g., regularly) or via a corresponding user input. For example, interrogation of the test identifier can be initiated during booting or starting up of the application module and/or via a test trigger signal (e.g., via an external communication interface, a test button, or a reset button).

The fact that executing the test mode occurs after recognition of the test identifier means that after recognition of the test identifier, the test mode is started or, if the latter has already started, the test mode is maintained. The fact that testing of the user application is performed after recognition of the test identifier means that the testing of the user application is performed after recognition of the test identifier, or that an already running test of the user application is continued.

Furthermore, provision can be made for the application module to comprise a test storage device or to be connected to a test storage device, and for the test storage device to be writable without inclusion of the control device and/or an automation engineering system in accordance with the present description.

The fact that the test storage device is writable without inclusion of the control device and/or an automation engineering system has the advantage that it is possible to write to the test storage device without the control device and/or the automation engineering system being required. That enables, for example, operation of the application module, for example, for testing a user application, without the control device and/or the automation engineering system being involved. This enables improved and/or simplified testing of a user application with an application module configured in this way.

Here, the application module, the control device and the automation engineering system can be configured in accordance with the presently disclosed embodiments.

The test storage device and the application module can furthermore be configured such that the test storage device is readable by the application module if it is connected to the application module or if the application module comprises the test storage device.

The fact that the test storage device is writable or is written to without inclusion of the control device and/or an automation engineering system in accordance with the disclosed embodiments can be configured such that the test storage device is writable or is written to by an electronic device if the test storage device is communicatively connected to the electronic device, and without the control device and/or an automation engineering system in accordance with the disclosed embodiments needing to be concomitantly included or being involved in the writing. Here, the communicative connection between the test storage device and the electronic device can exist permanently or can exist only temporarily.

By way of example, the test storage device can be configured and attached such that it is writable and/or is written to by an application engineering system in accordance with the disclosed embodiments if the test storage device is communicatively connected to the application engineering system, and without the control device or an automation engineering system in accordance with the disclosed embodiments needing to be included or being involved in the process. Here, the communicative connection between the test storage device and the application engineering system can exist permanently or can exist only temporarily.

The test storage device can, e.g., be fixedly connected to the application module or be integrated into it or can be releasably connected to the application module. Here, the test storage device can, for example, be communicatively, mechanically and/or electrically connected to the application module. A communicative connection between test storage device and application module can be configured, e.g., as a wireless communication connection (e.g. via mobile radio, WLAN, Bluetooth, NFC or comparable communication connections) or as a wired communication connection.

The test storage device can be configured, e.g., as a RAM memory (RAM: random access memory), an EPROM memory or a comparable writable electronic memory. It can be formed, e.g., as a memory fixedly built into the application module, or else as a memory releasably connectable to the application module. Such a memory releasably connectable to the application module can be configured, e.g., as an SD card, a USB stick or a comparable storage device. Furthermore, the test storage device can be configured as a computer, an external data drive, an external data server, an NFS (network file system), a storage unit in a cloud or a similar storage device.

Furthermore, the test storage device can additionally also be writable by the control device and/or an automation engineering system in accordance with the disclosed embodiments or can be readable by such devices.

Here, the application module can be configured such that the test storage device is releasably connected to the application module.

Here, the test storage device can in particular be communicatively releasably connected to the application module. In this case, the communication connection between test storage device and application module can, as necessary, be released or interrupted or can be re-established or established. A test storage device communicatively releasably connected or connectable to the application module can be configured, for example, as a memory card, an SD card, a USB stick or comparable storage device. Furthermore, a test storage device communicatively releasably connected or connectable to the application module can be configured as an external data drive, an external data server, an NFS (network file system), a storage unit in a cloud or a similar storage device.

Moreover, the test storage device can also be mechanically or/and electrically releasably connected to the application module. Here, once again the mechanical and/or electrical connection can be interrupted or released or can be established or re-established. Such a test storage device mechanically and/or electrically releasably connected to the application module can be configured, for example, as a memory card, an SD card, a USB stick or a comparable storage device.

Here, the application module can in turn be configured in accordance with the disclosed embodiments.

Such an embodiment of the application module has the advantage that such a flexible coupling of the test storage device enables simplified communication with the application module, for example, for the purpose of testing a user application. This improves and/or simplifies testing of a user application with such an application module.

The application module can furthermore be configured such that the test storage device is writable or is written to via an external communication interface of the application module.

Here, the external communication interface of the application module can be configured, for example, as a wired interface or a wireless interface.

In the case of a wired interface, for example, a plug connector can be provided on the application module for connection to a corresponding plug counterpart of an associated communication line. The application module can comprise a corresponding protocol stack for communication via the external communication interface. Such a wired interface can be configured, for example, as an Ethernet interface, a fieldbus interface or as any other wired communication interface.

Furthermore, the application module can also comprise a wireless interface. Such a wireless interface can be configured, for example, as a WLAN, Bluetooth, RFID, near field communication (NFC), mobile radio or any other wireless interface. For this purpose, the application module can optionally comprise a corresponding transmitting and/or receiving device and/or a corresponding antenna. Furthermore, the application module can also comprise a corresponding protocol stack for communication via the wireless interface.

For communication via the communication interface, or for writing to the test storage device, the application module can have a corresponding network address, for example. Furthermore, the test storage device itself can also comprise a specific network address or else network identifier or network ID.

Here, the application module can be configured, for example, such that it requests specific data from an external device, which data are then transferred to the application module via the communication interface and are then stored in the test storage device.

Furthermore, the application module can also be configured such that data are transferred to the application module from an external device via the communication interface of the application module and are then stored in the test storage device. Here, for example, provision can be made for the transferred data to be stored in the test storage device under the control of the external device. For example, provision can also be made for the transferred data to be transmitted from the external device and passed to the application module and then stored in the test storage device under the control of the application module.

Furthermore, provision can be made for test data for the testing of the user application to be stored on the test storage device. In one embodiment in this regard, the test data furthermore constitutes test input data for use by the application module and/or target result data constitutes a predefined result of the processing of the test input data by the application module. Provision can moreover advantageously be made for the test data to comprise test input data for use by the user application in the application module, and/or to comprise target result data constituting a predefined result of the processing of the test input data by the user application in the application module.

In this case, the test data can, for example, be configured as software or a software application or can comprise such software or such a software application. This software can be configured, for example, as execution code, such as interpretable code (e.g., in the “Python” programming language) or as converted or compiled code (e.g., in the programming languages C, or Mendix). Such software or software applications can be or can comprise, for example, a program for making available a specific functionality, a simulation program, a model trained via machine learning (an ML model) or the like.

Furthermore, the test data can comprise test configurations, where such test configurations can comprise, for example, information about which test can or ought to be performed, and how such a test ought to be performed or ought to proceed.

The test data can also comprise a test identifier in accordance with the disclosed embodiments. Here, the presence of test data in the test storage device can furthermore already constitute a test identifier in accordance with the disclosed embodiments.

Test data can also furthermore be or can comprise data that are used for testing a user application. Here, the test data can be configured, for example, as test input data such that the user application is executed using the test data. Provision can furthermore be made for test result data to be present, constituting a planned result of the execution of assigned test input data with the user application. In this regard, the test data can, for example, comprise such test input data and assigned test result data or can be formulated as such data.

In this regard, for example, in the case of a user application that is formed as a trained neural network and that is configured for processing image information, test input data may be various images, where associated test result data then constitute planned results, assigned to the respective test images, of the processing of the respective images by the neural network. In this way, data could then be made available by the application module, for example, via which the proper functionality of the neural network implemented on the application module can be checked. This checking may be particularly expedient or necessary, for example, if hardware elements that were not implemented on a development system for the neural network are installed on the application module. Such hardware may be, for example, corresponding hardware accelerators for the improved processing of neural networks.

With the aid of test input data and assigned test result data, it is then possible, for example, to check whether a corresponding user application is also executed properly on the hardware of the application module.

Furthermore, the test data can also be configured as information regarding an external storage device, an external data processing device and/or externally stored data, or comprise such information. Here, such information regarding an external storage device, an external data processing device and/or externally stored data can be configured, for example, as hyperlinks, network addresses, file names, or ID information.

Such externally stored data can, for example, in turn be configured as test data in accordance with the disclosed embodiments.

In this way, the application module can be upgraded to obtain or be supplied with corresponding test data in accordance with the disclosed embodiments from external storage devices or data processing devices, such as a computer, an external data memory, an NFS, or a cloud.

This further simplifies the testing of a corresponding user application because corresponding test data do not need to be transferred to the application module, for example, until a test is performed for a user application, and therefore storage space for keeping such test data in the application module can be reduced or saved, for example.

Furthermore, provision can also be made for the test storage device to comprise the user application and/or application configuration data for configuring the application module and/or the user application.

Application configuration data may be, for example, data used to configure the application module for an intended execution of a user application formed as a software application or execution code. Furthermore, such application configuration data can comprise, for example, data about hardware components connected to the application module or the control device or hardware components comprised by the control device. Consequently, application configuration data can also comprise communication parameters or communication settings for communication between the application module and other hardware devices and/or other components of the control device.

Application configuration data can also comprise data for configuring the user application or for adapting the user application for example to specific stipulations of the application module and/or of the control device or other components of the control device.

Application configuration data may furthermore also be data for preparing specific test input data and/or test result data for the application module and/or a specific user application.

Furthermore, the test storage device can comprise the test identifier.

Here, the test identifier can be configured, for example, in accordance with the disclosed embodiments.

In one advantageous embodiment, the test storage device comprises ID information in relation to an external storage device, where the application module is configured for recognizing data on the external storage device and/or for requesting and/or loading data from the external storage device. In particular, in this case, the application module can be configured for recognizing, requesting and/or loading test data for testing the user application, application configuration data for configuring the application module, application configuration data for configuring the user application and/or the test identifier in accordance with the disclosed embodiments on and/or from the external storage device.

The presently contemplated embodiment has the advantage that as necessary, such as in the context of testing a user application, data for implementing or for supporting a test of a user application can be transferred directly from an external storage device to the application module. In this way, test data in accordance with the presently contemplated embodiment can be transferred to the application module in a simplified manner, for example. In this way, for example, storage space in the application module can be saved, or in this way it is also possible to use in each case updated test data for the use in the application module, such as in the context of testing a user application.

The ID information in relation to the external storage device may be, for example, a name, an identifier, a network address, a hyperlink or comparable information with which, for example, a storage device or data processing device within a computer network or a communication network can be recognized or are recognizable.

It is possible to recognize data on the external storage device, for example, via a corresponding file name, a file identifier, a data description and/or via comparable information.

For the requesting and/or loading, the application module can comprise, for example, a communication component that is structured in the manner of a client and that can request specific data, for example, from an external storage device formed as a server. Furthermore, the application module can also be configured to participate in a “publish-subscribe” communication scheme, for example, to subscribe to specific data or information, in the context of such a mechanism or a comparable mechanism.

The application module can furthermore also be configured such that it makes information available to available to an external storage device, which allows the external storage device to store data on the application module or in the test storage device.

The external storage device can be configured, for example, as a data processing device, a computer, a network storage unit, an NFS, an external drive, an external hard disk, an SSD, or a comparable storage device.

The external storage device can be indirectly or directly connected or connectable to the control device and/or the application module via a data network or a communication connection, for example. Here, the external storage device can be connected to the application module and/or the control device via corresponding wireless communication or wired communication, for example.

The objects and advantages are also achieved in accordance with the invention by a method for testing a user application with an application module in accordance with the disclosed embodiments for a control device where the method comprises: loading test input data for testing the user application, loading target result data constituting a planned result of the processing of the test data by the user application, and testing the user application using the test input data and the target result data, where the application module is configured in accordance with the disclosed embodiments and is in the test mode during the testing of the user application.

Here, the method can be configured, for example, as a computer-implemented method.

Furthermore or alternatively, the application module can be configured in accordance with the disclosed embodiments and furthermore loading the test input data and/or loading the target result data and/or testing the user application occur(s) without inclusion of the control device and/or the automation engineering system.

In a further alternative, the application module can be configured in accordance with the disclosed embodiments, where the application module comprises a control device simulation application for simulating a control functionality of the control device, and where testing the user application occurs with participation of the control device simulation application.

Here, testing the user application, the user application, the application module, the test input data, the test result data, the test mode, the control device, the automation engineering system, the control device simulation application and/or the control functionality can be configured in accordance with the disclosed embodiments.

Here, for loading test input data and/or target result data, provision can be made of loading the test input data into the application module and/or into a test storage device of the application module in accordance with the disclosed embodiments.

Loading test input data and/or target result data can be configured, for example, such that a storage device releasably connectable to the application module is provided, for example, a memory card or SD card, and the test input data and/or the target result data on a first computer system or an external data processing device are stored on the storage device releasably connectable to the application module. When storing these data on this storage device, it is possible for the storage device, for example, not to be connected to the application module, but rather only to the external data processing device. Here, the external data processing device can, for example, comprise an application engineering system in accordance with the disclosed embodiments and/or storing the test input data and/or target result data can be effected by such an application engineering system.

As a further possible step for loading the test input data and/or target result data, the storage device with the data stored thereon that is releasably connectable to the application module can then be communicatively or mechanically and communicatively connected to the application module, such that an operating system of the application module and/or the user application then have/has access to the data stored in the storage device.

Loading the test input data and/or target result data can, for example, also occurs such that these data are stored in a storage device of the application module, for example, a test storage device in accordance with the disclosed embodiments, via a communication connection from an external storage device or an external data processing device or a comparable device.

Loading test input data and/or target result data can also occur, for example, in the context of testing, directly from an external data processing device and/or storage device in accordance with the disclosed embodiments.

Testing the user application using the test input data and/or the target result data can then occurs, for example, such that test input data are loaded from a storage device of the application module, or directly from an external data drive, and then the user application is executed using the test input data. Furthermore, testing the user application can occurs such that after testing the user application has been executed, for example, using test input data in accordance with the disclosed embodiments, result data of this test are compared with assigned target result data.

This comparison of the target result data with result data from testing the user application can then be performed, for example, directly in the application module. Furthermore, provision can also be made for result data determined in the context of testing the user application for example to be stored again on a data carrier releasably connectable to the application module and then later to be compared with corresponding target result data in a different data processing device. Provision can also be made for result data determined during the testing of the user application to be transferred to a different data processing device or data storage device, and then to be read from there and compared with corresponding target result data on a corresponding different computing device or data processing device.

Starting the test mode can be configured, for example, in accordance with the disclosed embodiments. Here, the test mode can be started, for example, after a corresponding test identifier in accordance with the disclosed embodiments has been recognized by the application module. Such an interrogation or recognition of such a test identifier can occur, for example, during the booting or restarting of the application module, or otherwise in response to a corresponding user input or a corresponding electrical or electronic trigger signal. Such a trigger signal can be initiated, for example, via a corresponding switch or a corresponding pushbutton on the application module itself. Furthermore, such a trigger signal may be a trigger signal that is transferred via a communication connection and that is transmitted or initiated, for example, by an application engineering system, a control device, an automation engineering system or some other data processing or computing device.

The objects and advantages are also achieved in accordance with the invention by a method for writing to a test storage device for an application module in accordance with the disclosed embodiments via an application engineering system in accordance with the disclosed embodiments, where the method comprises: processing test input data via the user application and storing target result data determined in the process, and writing the test input data and/or the target result data to the test storage device via the application engineering system.

Here, the method can be configured, for example, as a computer-implemented method.

Here, the test storage device, the application module, the application engineering system, the test input data, the user application, the target result data and writing to the test storage device can be configured in accordance with the disclosed embodiments.

In order to prepare for the testing of a user application with the application module, the method in accordance with disclosed embodiments can be configured, for example, such that in the application engineering system, for example, test input data are processed via the user application and the result of this processing is stored as target result data.

For example, a target of testing the user application on the application module may then be that during the execution of the user application on the application module, during the processing of the test input data by the user application executed on the application module, the target result data are likewise generated as the result. If this is the case, then this indicates a correct functionality of the user application on the application module.

In the context of such a method, for example, provision can be made for test input data to be stored in the test storage device.

Care is then taken to ensure that the application module also has access to the test storage device, such as by the connection of the test storage device to the application module. If the test storage device is already part of the application module, hen this step is omitted because the communication connection to the application module has already been established.

This is followed by testing the user application in the application module such that the test input data are processed via execution of the user application and test result data are generated in the process.

This is followed by comparing the test result data with the target result data. This comparison can likewise be executed in the application module, for example. For this purpose, for example, in addition to the test input data, the associated target result data can then also be written to the test storage device (for example, by the application engineering system), such that the target result data are also known to the application module.

Furthermore, the test result data determined in the context of the test of the user application on the application module can also be transferred to a different data processing device, for example, the application engineering system, and the comparison of the test result data with the target result data occurs there. For this purpose, the test result data can, for example, also be stored in the test storage device and/or can be transferred from the application module to the external data processing device.

In an alternative embodiment, only target result data is written to the test storage device. Associated test input data can be transferred to the application module, for example, via a communication connection directly from an external data processing device and/or corresponding devices, such as a camera, a camera simulation, a sensor, a sensor simulation or comparable data processing devices or devices. The target result data can once again be generated, for example, in an external data processing device, such as the application engineering system.

The objects and advantages are also achieved in accordance with the invention by a method for writing to a test storage device for an application module in accordance with the disclosed embodiments via an application engineering system in accordance with the disclosed embodiments, where the method comprises: processing test input data via the user application and storing target result data determined in the process, storing the test input data and/or the target result data in a storage device which is addressable by means of ID information, and writing the ID information to the test storage device via the application engineering system.

Here, the method can be configured, for example, as a computer-implemented method.

In the present contemplated embodiment, for example, provision can be made for generating the target result data for testing the user application on the application module, for example, by the execution of the user application on an external data processing device, such as the application engineering system, via corresponding test input data being processed by the user application in the context of the execution of the user application.

This is followed by storing the test input data and/or the target result data in a storage device, for example, a storage device in the same data processing unit in which the application engineering system is also executed, or a further storage device in a different data processing unit or otherwise a different external storage device. Here, corresponding ID information is assigned to each of the storage devices mentioned. Such ID information can comprise, for example, a corresponding file name, a drive name, a folder structure, a network address, a hyperlink, and/or comparable ID information. Here, such ID information is configured such that obtaining this ID information enables the application module to access the target result data and/or test input data stored in the corresponding storage device if a communication connection between the application module and the corresponding storage device exists or has been set up.

In one advantageous embodiment, a test identifier in accordance with the disclosed embodiments is written to the test storage device.

Here, the test identifier, the application module and the test storage device can be configured, for example, in accordance with the disclosed embodiments.

The test identifier can be written to the test storage device, for example, by the application module itself. This writing of the test identifier to the test storage device by the application module can occur, for example, in a manner instigated by a corresponding command from a different component of the control device, a corresponding command from an external data processing and/or communication device and/or by a user.

The test identifier can, for example, also be written to the test storage device by a different component of the control device, an external data processing device and/or an application engineering system in accordance with the disclosed embodiments.

In the case where the application module comprises the test storage device, when the test identifier is written to the test storage device, the external data processing device, the different component of the control device and/or the application engineering system must then be communicatively connected to the application module in order to write the test identifier to the test storage device.

Furthermore, the test storage device can also be releasably connectably connected to the application module. Here, provision can be made for the test storage device not to be communicatively connected to the application module when the test identifier is written to the test storage device. This can be realized, for example, such that the test storage device is configured as an SD card and, for the purpose of writing the test identifier to the test storage device, is removed from the application module and, for example, communicatively connected to an external data processing device and/or an application engineering system in accordance with the disclosed embodiments.

Furthermore, provision can be made for the user application to be written to the test storage device.

Here, the user application, the application module and the test storage device can be configured for example in accordance with the disclosed embodiments.

The user application can be written to the test storage device, for example, by the application module itself. This writing of the user application to the test storage device by the application module can occurs, for example, in a manner instigated by a corresponding command from a different component of the control device, a corresponding command from an external data processing and/or communication device and/or by a user.

The user application can, for example, also be written to the test storage device by a different component of the control device, an external data processing device and/or an application engineering system in accordance with the disclosed embodiments.

In the case where the application module comprises the test storage device, when the user application is written to the test storage device, the external data processing device, the different component of the control device and/or the application engineering system must then be communicatively connected to the application module in order to write the user application to the test storage device.

Furthermore, the test storage device can also be releasably connected or connectable to the application module. Here, provision can be made for the test storage device not to be connected to the application module when the user application is written to the test storage device. This can be realized, for example, such that the test storage device, for the purpose of writing the user application, is or has been removed from the application module and, for example, is connected to an external data processing device and/or an application engineering system in accordance with the disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in greater detail below by way of example with reference to the accompanying figures, in which:

FIG. 1 shows a production system with automatic optical inspection (AOI) and a programmable logic controller (PLC) with an AI module;

FIG. 2 shows a setup for configuring the AI module in accordance with FIG. 1 and for testing a neural network implemented in the AI module;

FIG. 3 shows an alternative setup for configuring the AI module and testing the neural network in accordance with FIG. 1;

FIG. 4 shows an alternative production system with AOI and a soft PLC with an AI app;

FIG. 5 shows a setup for configuring the AI app in accordance with FIG. 4 and for testing a neural network implemented there;

FIG. 6: shows an alternative setup for configuring the AI app in accordance with FIG. 4 and testing the neural network; and

FIG. 7 is a flowchart of the method in accordance with an embodiment of the invention.

### DETAILED DESCRIPTION OF THE EXEMPLARY EMBODIMENTS

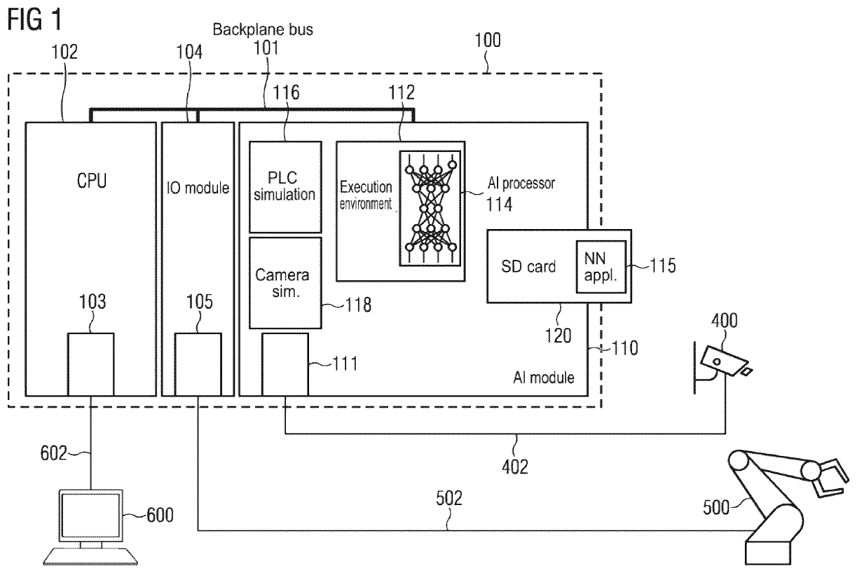

FIG. 1 shows a production system comprising a robot 500 controlled by a modular programmable logic controller (PLC) 100. The production system in FIG. 1 furthermore comprises product control via automatic optical inspection (AOI) using a camera 400, where the AOI system comprises image evaluation using an artificial intelligence (AI) module 110 of the PLC 100.

Here, the programmable logic controller 100 is one exemplary embodiment of a control device in accordance with the present disclosure. The AI module 110 is one exemplary embodiment of an application module in accordance with the present disclosure.

Here, the AOI system functions such that the camera 400 photographs products produced by the robot 500 after they have been produced, and these images are transferred to the AI module 110 and evaluated in the AI module 110 of the PLC 100. If a defective product is recognized, the robot 500 then segregates it from the automated production sequence for the purpose of subsequent monitoring.

Here, the AI module 110 is configured for image evaluation using a neural network. For this purpose, the AI module 110 comprises an execution environment 112 with an AI accelerator chip 114 configured for accelerated operation or for accelerated execution of a neural network application (NN application) 115 used in the AI module, or of a neural network 115 implemented in the AI module. Here, the neural network application 115 is stored as executable code on an SD card 120, which is releasably connected to the AI module 110 in FIG. 1. Here, the neural network 115 is realized as executable code, e.g., in a corresponding programming language (e.g., “Python”).

Here, the SD card 120 is one exemplary embodiment of a test storage device in accordance with the present disclosure, and the neural network application (NN application) 115 or the neural network 115 is one exemplary embodiment of a user application in accordance with the present disclosure.

In the description below, the neural network application 115 or NN application 115 is in some instances also called the neural network 115.

Here, the NN application 115 stored on the SD card 120 is a neural network 115 trained via a supervised learning method, for example. Here, the neural network 115 was trained so as to be able to distinguish products of entirely satisfactory quality from defective or possibly defective products based on the images recorded by the camera 400. Such training can occur, for example, such that for a multiplicity of product images each image was assigned information (a “label”) as to whether this involves a product of entirely satisfactory quality or a defective product. With these training images and the associated “labels”, the neural network 115 can then be trained by a supervised learning method in accordance with the prior art. In the present case, the NN application 115 was trained, for example, via such a method for the recognition of defective products.

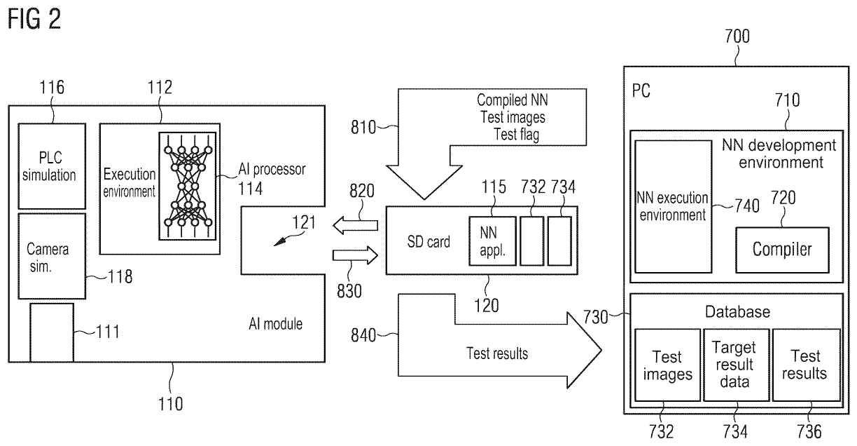

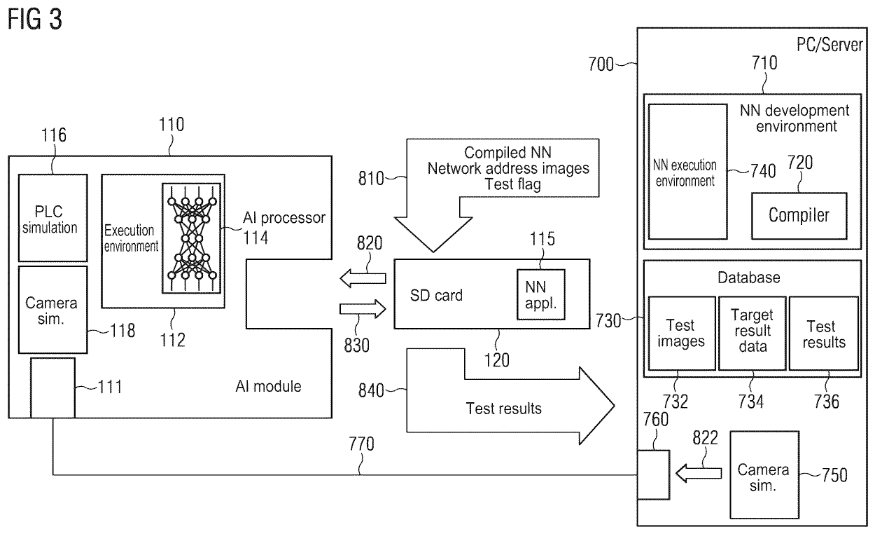

The AI module furthermore comprises an Ethernet interface 111, via which the AI module 110 is communicatively connected or connectable to the camera 400 or other external devices or data processing devices, such as computers or the like, via an Ethernet connection 402. Furthermore, the AI module 110 comprises a PLC simulation 116 and a camera simulation 118, the functionality of which, in the context of configuring the AI module 110 and/or testing the NN application 115, will be explained in greater detail in association with FIGS. 2 and 3.

Furthermore, the PLC 100 comprises a central processing unit 102 or else CPU 102, which is configured, for example, to execute a control program for controlling the robot 500 and an AOI quality control method via the camera 400. The central processing unit 102 of the PLC 100 furthermore comprises an Open Platform Communications Unified Architecture (OPC UA) interface 103 for communication with an automation engineering system 600 via an OPC UA communication connection 602.

For communication between the PLC 100 and the robot 500, the PLC 100 furthermore comprises an input-output module 104 or IO module 104 having a fieldbus interface 105. Here, the PLC 100 is configured such that control signals are transferred to the robot 500 from the PLC 100 via the IO module 104 and a fieldbus connection 502. Corresponding sensor signals or other pieces of information from the robot 500 to the PLC 100 are transferred back to the IO module 104 of the PLC 100 via the fieldbus connection 502. Furthermore, the central processing unit 102, the IO module 104 and the AI module 110 are communicatively connected via a backplane bus 101 of the PLC 100, where the backplane bus 101 is configured for real-time communication between the modules 102, 104, 110 of the PLC 100.

Here, the PLC 100 can be configured such that control commands are generated, for example, in the context of the execution of a corresponding control program in the central processing unit 102, are transferred to the IO module 104 via the backplane bus 101 and are then transferred to the robot 500 via the fieldbus interface 105 of the IO module 104 and the fieldbus connection 502. Corresponding sensor signals or other pieces of information from the robot 500 are then, for example, in turn transferred via the fieldbus connection 502 and the fieldbus interface 105 of the IO module 104 and furthermore the backplane bus 101 to the central processing unit 102 of the PLC 100 where they are again used as an input variable for the control program, for example.

The automation engineering system is configured for configuring the PLC 100. In this context, for example, the abovementioned control program or the abovementioned control programs is or are created via the automation engineering system. Furthermore, for example, the fieldbus connection 502 to the robot 500 and the communication via the backplane bus 101 between the modules 102, 104, 110 of the PLC 100 are configured and parameterized. The modules 102, 104, 110 of the PLC 100 are also parameterized, configured and set up via the automation engineering system.

FIG. 2 schematically illustrates a system and a method sequence for testing the NN application 115 with the AI module 110. Here, the AI module 110 is configured as already explained in greater detail in association with FIG. 1, the SD card 120 having been removed from the AI module 110 in the state illustrated in FIG. 2. Besides the NN application 115, furthermore, test images 732 and desired or target results 734 are stored on the SD card 120, in which case the embodiment, arising and use of the desired or target results 734, will be explained in even greater detail below.

In this case, the test images 732 are exemplary embodiments of test input data in accordance with the present disclosure, and the desired or target results 734 are exemplary embodiments of target result data in accordance with the present disclosure.

Furthermore, FIG. 2 illustrates a PC 700 comprising a development environment 710 for creating and testing a neural network or the neural network application 115. Here, this development environment 710 for creating and testing the neural network 115 is also called NN development environment 710 hereinafter. The NN development environment 710 furthermore comprises an execution environment 740 for executing and testing a neural network developed in the NN development environment 710.

Furthermore, the NN development environment 710 comprises a compiler 720 for various acceleration processors 114 or acceleration software applications 253 which are configured for accelerated execution of neural network applications. One example of such an acceleration processor is the AI processor 114 of the AI module 110. With the compiler 720, a neural network developed in the NN development environment 710 can be converted and/or adapted for improved or optimized execution on one of the aforementioned acceleration processors 114 or acceleration software applications 253. In general, the conversion of a neural network application via the compiler 720 is necessary in order that the neural network is then executed correctly and in an optimized manner on a corresponding acceleration processor 114, 253, such as the AI processor 114.

Furthermore, the PC 700 comprises a database 730 comprising test images 732 for testing the NN application 115 developed in the NN development environment 710. Furthermore, the database comprises desired or target results 734 constituting the results arising by virtue of the test images 732 being applied to the NN application 715 executed in the neural network execution environment 740 of the NN development environment 710.

In order to use the NN application 115, developed in the NN development environment 710 in the PC 700, in the AI module 110, the compiler 720 must then convert the NN application 115 into an NN application 115 suitable or optimized for the AI processor 114.

As a result of the conversion of the NN application 115 by the compiler 720, it may then be the case that the converted NN application 115, upon execution in the AI processor 114, or at least in interaction with the AI processor 114, has a functionality that differs at least in detail. This must then be checked or tested in the context of a test of this converted NN application 115 in the AI module 110.

The test proceeds here as described below. In a first work step 810, represented as arrow 810 in FIG. 2, the converted or compiled NN application 115, in some instances also just called NN application 115 hereinafter for simplification, is stored on the memory card or SD card 120. Furthermore, the test images 732 and also the desired or target results 734 are likewise stored on the SD card 120 in this work step 810. Moreover, in this step 810, a test flag is also stored on the SD card and on the basis thereof the AI module 110 recognizes that a test of the compiled NN application 115 stored on the SD card 120 is intended to be started.

In a next work step 820, the SD card 120 is then inserted into a corresponding SD card slot 121 of the AI module 110 and is communicatively connected to the AI module 110 via a corresponding plug connector (not illustrated in FIG. 2). The AI module 110 with the SD card 120 is now in the state in which these components are illustrated in FIG. 1.

The AI module 110 is configured such that during the booting, starting and/or restart of the AI module 110, the operating system of the AI module 110 checks whether an SD card 120 is present in the AI module 110 and, if so, whether a test flag is stored on the SD card 120. If the operating system of the AI module 110 finds such a test flag on the SD card 120, then a test mode is started in the AI module 110.

Here, the test mode is configured such that the NN application 115 can be executed in the AI module 110, without further modules 102, 104 of the PLC 100—or other components of the automation system, such as the camera 400 or the robot 500—being required. Furthermore, the test mode of the AI module 110 is configured such that on the SD card information regarding test data for testing a corresponding NN application, for example, the compiled NN application 115 in the present exemplary embodiment, is searched for and read out. In the present example, such test data are, for example, the test images 732 for testing the compiled NN application 115. However, such information regarding test data may also be, for example, a network address, a network name, a hyperlink, an IP address or comparable information under which corresponding test data, for example, the test images 732 in the present case, are stored and are downloadable by the AI module, for example. One exemplary embodiment of such a configuration will be explained in greater detail in association with FIG. 3, for example.

The AI module 110 is configured such that it is configured as an expansion module with respect to the central module 102 of the PLC 100 and interacts with the central module 102 during the normal operating sequence of the PLC 100. In order that the AI module 110 functions properly in the test mode even without the central module 102, the AI module 110 comprises the PLC simulation 116, which comprises the functionality that is necessary for the functioning of the AI module 110 and that is normally made available by the central module 102.

Such a basic functionality of the PLC simulation 116 in the present exemplary embodiment includes, e.g.:
(1) simulation of triggers normally transmitted by the central module 102,
(2) provision of the image if an image is requested by the NN application 115,
(3) provision of the second image at the request of the NN application 115,
(4) collection of the results 736 of the processing of the images with the compiled neural network 115, and
(5) writing the results 736 to a file stored on the SD card with an identifier of the inputs used (this is not illustrated in FIG. 2).
(6) In a last step, the results 736 of the execution of the compiled NN application 115 on the AI module 110 are compared with the desired or target results 734 and a corresponding message is output and/or stored on the SD card with respect to whether all results determined with the application module 110 correspond to the desired or target results 734, or for which of the test images 732 there are deviations between the results determined by the AI module 110 and the desired or target results 734.
(6a) In an alternative embodiment of the aforementioned step (6), this comparison of the results 736 determined by the AI module 110 with the desired results 734 can also occurs in the PC 700. For this purpose, the results 736 determined by the AI module 110 are then written to the SD card 120 and, in a further execution step 840, the SD card is in turn communicatively connected to the PC 700. Then these results 736 are likewise stored in the database 730 in the PC 700 and the comparison between the desired or target results 734 and the results of the AI module 736 is performed in the PC 700.

The AI module 110 in the present exemplary embodiment is configured such that the neural networks 115 executed in the execution environment 102 expect images from a camera 400 via the Ethernet interface 111. As a result, the camera simulation 118 is provided in the AI module 110 for the proper execution of the test mode independently of the camera 400. If the execution environment 112 then requests an image for processing with the neural network 115, the test mode of the AI module 110 is configured such that the camera simulation 118 is then addressed instead. The camera simulation 118 then effects the reading in of the test images 732 and correspondingly forwards them to the execution environment 112.

FIG. 3 shows a further exemplary embodiment of the testing of the compiled NN application 115 on the AI module 110.

Here, the basic method sequence of the testing of the NN application 115 corresponds to the sequence already explained in association with FIG. 2. In contrast to the method sequence explained in association with FIG. 2, in the case of the alternative test sequence as illustrated in FIG. 3, the test images 732 are not stored on the SD card 120. Instead, in method step 810, only a network address of the test images 732, at which the test images 732 are loadable by the AI module 110 via an Ethernet connection 770, is stored besides the compiled neural network application 115 and the test flag.

After the SD card 120 has been introduced into the AI module 110 in method step 820, in the context of the execution of the compiled neural network application 115 by the execution environment 112 upon the request of one of the test images 732, the network address of the test images is then read in from the SD card 120 and, via the camera simulation 118 and the Ethernet interface 111, the corresponding image is read in from the database 730 of the PC 700 via the Ethernet connection 770. For this purpose, a camera simulation 750 is likewise provided in the PC 700 and, in an intermediate step 822, reads out the requested one or more test images 732 from the database 730 and transfers same to the AI module 110 via an Ethernet interface 760 of the PC 700 and the Ethernet connection 770.

In the AI module 110, the one or more test images 732 are then made available to the execution environment 112 via the camera simulation 118 and are processed with the compiled neural network 115 using the AI processor 114.

In the exemplary embodiment illustrated in FIG. 3, the test mode of the AI module 110 is, in this case, configured such that the results 736 obtained during the processing of the test images 732 with the compiled neural network 115 are stored directly in the database 730 directly via the Ethernet interface 111 of the AI module 110, the Ethernet connection 770 and the Ethernet interface 760.

In a subsequent step, the desired or target results 734 are then compared with the results 736 generated by the AI module 110 and the result of this comparison is output to a user.

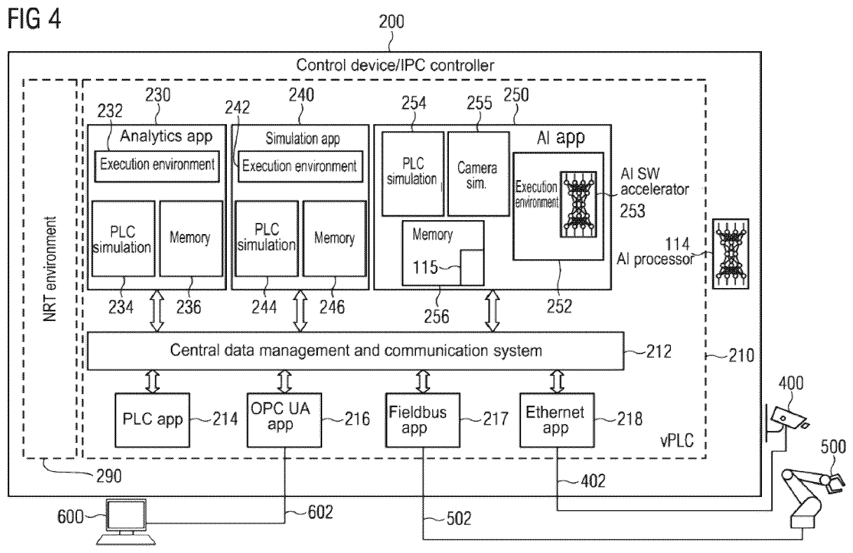

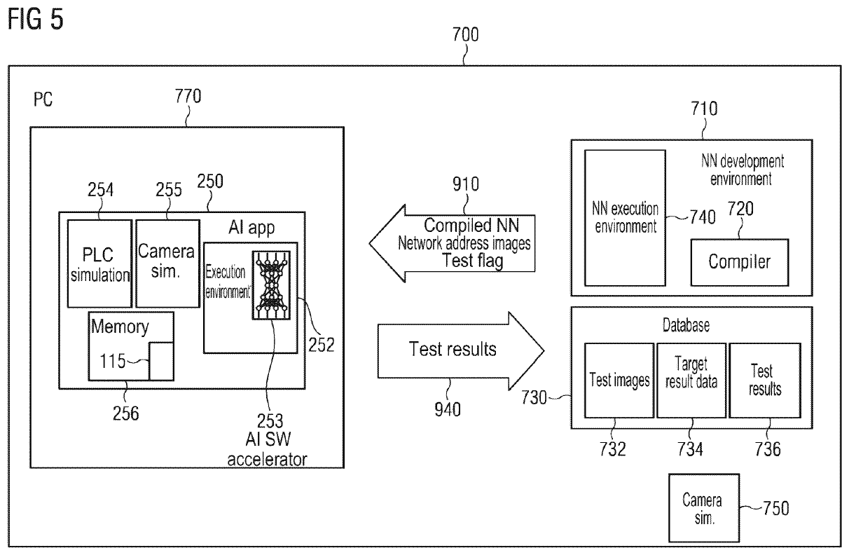

In FIG. 4, the automation system already explained in association with FIG. 1 is equipped with an alternative control device 200 formed as an industrial PC 200, instead of the PLC 100 illustrated in FIG. 1. The industrial PC 200 comprises a “soft PLC” 210 or “virtual PLC” (vPLC) 210. Here, the basic functionality of the system illustrated in FIG. 4, apart from the specific embodiment of the control device 200, corresponds to that of the system from FIG. 1. Components provided with identical reference signs in FIG. 4 and FIG. 1 correspond to one another.

The soft PLC 210 or vPLC 210 is configured as a programmable logic controller 210 realized using software. For this purpose, the soft PLC 210 is formed as a real-time execution environment 210 (RT environment) 210, where individual functionalities and/or modules of the PLC 210 are realized as software applications implemented in the RT environment 210.

Here, the soft PLC 210 or vPLC 210 and also the industrial PC 200 are exemplary embodiments of a control device in accordance with the disclosed embodiments.

Here, the soft PLC 210 illustrated in FIG. 2 comprises a PLC application 214 or PLC app 214 having essentially the basic functionalities of a programmable logic controller, for example, in accordance with the standard IEC 61131 and/or EN 61499. The PLC app 214 can, for example, also have or comprise the functionality of a central module of a programmable logic controller, such as a functionality of the central module 102 illustrated in FIG. 1.

Furthermore, the soft PLC 210 comprises a fieldbus interface application 217 or fieldbus app 217 for coupling the soft PLC 210 to a fieldbus 502. Here, the fieldbus app 217 can be configured, for example, as a Profinet app 217, an EtherCAT app 217, an EthernetIP app 217, a Profibus app 217 or a fieldbus app 217 for comparable fieldbuses.

The soft PLC 210 furthermore comprises an Ethernet interface application 218 or Ethernet app 218 for communication of the soft PLC 210 via the Ethernet protocol or a corresponding communication connection 402. Furthermore, the soft PLC 210 also comprises an OPC UA app or OPC UA interface application 216 for communication of the soft PLC 210 via the OPC UA protocol, e.g., via a corresponding OPC UA communication connection 602.

Furthermore, the soft PLC 210 comprises three freely programmable applications 230, 240, 250 configured as an AI application 250 or AI app 250 (AI: artificial intelligence), a simulation application 240 or simulation app 240, and an analytics application 230 or analytics app 230. Here, the AI app 250, the simulation app 240 and the analytics app 230 are examples of application modules in accordance with the disclosed embodiments.

Here, the AI app 250 has essentially the functionality of the AI module 110 illustrated in FIG. 1. For this purpose, the AI app 250 comprises an execution environment 252 for execution of a neural network application 115, or NN application 115, which is stored in a user data memory 256 and that corresponds to the NN application 115 and/or compiled NN application 115 as already explained in association with FIGS. 1-3. The NN application 115 is in turn one example of a user application in accordance with the disclosed embodiments.

Furthermore, the execution environment 252 of the AI app 250 comprises an AI software accelerator 253 formed as a software module and configured for accelerated execution of the NN application 115. Alternatively, the execution environment 252 of the AI app 250 can also access an AI processor 114, established using hardware, of the IPC 200 in order to attain accelerated execution of the NN application 115. Here, the AI processor 114 of the IPC 200 corresponds to the AI processor 114 as already explained in association with FIG. 1.

Furthermore, the AI app 250 comprises a PLC simulation 254 and a camera simulation 255, which in terms of their functionality correspond to the PLC simulation 116 and camera simulation 118 of the AI module 110 already explained in association with FIGS. 1-3.

The simulation app 240 of the soft PLC 210 is configured for execution of a simulation program stored in a user data memory 246 of the simulation app 240. Here, the simulation program is one example of a user application in accordance with the present description. In order to make it possible, for example, to test the simulation program within the simulation application 240, even if the simulation application 240 is not installed in the soft PLC 210, the simulation application 240 furthermore comprises a PLC simulation 244. The PLC simulation 244comprises, for example, the functionalities of the PLC app 214 that are necessary for proper execution of the simulation program in the simulation app 240.

The analytics app 230 is also constructed in a comparable manner, and makes available an execution environment 232 configured for execution of an analytics program for the mathematical analysis of data, where the analytics program is stored in a user data memory 236. Here, too, the analytics program is one example of a user application in accordance with the disclosed embodiments.

In order to also make it possible to test the analytics program in the analytics app 230 if the latter is not implemented in the soft PLC 210, the analytics app 230 also comprises a PLC simulation 234 for simulation of those functionalities of the PLC app 314 that are necessary for proper execution of the analytics program within the analytics app 230.

For communication within the soft PLC 210, the soft PLC 210comprises a central data management and communication system 212, via which the applications 214, 216, 217, 218, 230, 240, 250 of the soft PLC 210 are communicatively connected. Here, the central data management and communication system 212 is configured both for real-time communication between the applications 214, 216, 217, 218, 230, 240, 250 of the soft PLC 210 and for non-real-time communication between the applications 214, 216, 217, 218, 230, 240, 250 of the soft PLC 210. Here, the central data management and communication system 212 can be configured, for example, for transferring data at least inter alia via a “publish-subscribe” communication scheme (pub-sub communication scheme), and/or can at least inter alia also use a “shared memory” or a “dual port RAM”.

Here, the functionality of the IPC 200 or the soft PLC 210 corresponds to that of the PLC 100 as already described in association with FIG. 1. With a control program executed within the PLC app 214, the robot 500 is controlled by corresponding control signals being output to the robot 500 via the fieldbus app 217 and the fieldbus connection 502. Via the same communication connection, corresponding sensor signals of the robot 500 and also other information from the robot 500 are transferred back to the control program or the PLC app 214.

For process control of the products manufactured by the robot 500, images of the manufactured products are once again recorded by the camera 400 and they are transferred to the soft PLC 210 via an Internet line 402 and the Ethernet app 218. The evaluation of the recorded images occurs within the AI app 250 of the soft PLC 210 by virtue of the images being analyzed by the neural network 115 of the AI app 250 in the manner already described in association with FIG. 1. Here, the analysis results are also output from the AI app 250 to the PLC app 214 via the central data management and communication system 212. If a result determined by the AI app 250 reveals that a manufactured product might have deficiencies and should be subsequently monitored, then a corresponding notification is output to a user. At the same time, in this case, a corresponding command can be output to the robot 500 to the effect that the robot 500 immediately segregates this product and takes it to a place provided therefor.

For configuring the soft PLC 210 and creating a control program for controlling the robot 500 and also the AOI system using the camera 400, an automation engineering system 600 is also provided in the system illustrated in FIG. 4, and corresponds to the automation engineering system 600 as already explained in association with FIG. 1. The automation engineering system 600 in accordance with FIG. 4 is once again connected to the soft PLC 210 via an OPC UA communication connection 602 and the OPC UA app 216.

FIG. 5 once again illustrates the PC 700 comprising the NN development environment 710 and the database 730 already explained in greater detail in association with FIGS. 2 and 3. Here, identical reference signs also correspond to the same components.

FIG. 5 illustrates one exemplary embodiment of a test of an NN application 115 created in the NN development environment 710 with the AI app 250. Here, the basic sequence of the test corresponds to that as already illustrated and explained in association with FIGS. 1-3. Hereinafter, therefore, essentially only differences in the sequence will be discussed that relate to differences between the sequences illustrated in FIGS. 2 and 3 and the sequence illustrated in FIG. 5.

In the exemplary embodiment illustrated in FIG. 5, the AI app 250 was installed in a container environment 770 in the PC 700. For the container realization of the AI app 250, it is possible to use Kubernetes and/or Docker technology, for example, which inter alia is also available as open source.

Here, the NN application 115 was adapted by the compiler 720 of the NN development environment 710 for optimum execution with the AI software accelerator 253 of the AI app 250.

For testing the compiled NN application 115, in a first step 910, represented as arrow 910 in FIG. 5, the NN application is transferred together with file information for the test images 732 and also the test flag to the AI app 250 and stored there in the user data memory 256 thereof.

In the context of a restart of the AI app 250 in the container 770, the test flag is interrogated. Once the test flag has been recognized, the AI app 250 goes into the test mode already explained in association with FIGS. 1-3 and the present disclosure. After recognition of the file information for the test images 732, the test images 732 from the database 730 are loaded by the AI app 250 and are processed by the compiled neural network in the context of the execution of the compiled neural network 115 in the execution environment 252 of the AI app 250. The test results 736 obtained in the process are then stored in the user data memory 256.

These test results 736 are then transferred into the database 730 and stored there in a subsequent step 940, likewise symbolized by an arrow in FIG. 5. Afterward, the NN development environment 710 then compares the desired or target test results 734 with the test results 736 of the compiled neural network 115 and if appropriate outputs corresponding comparison results to a user.

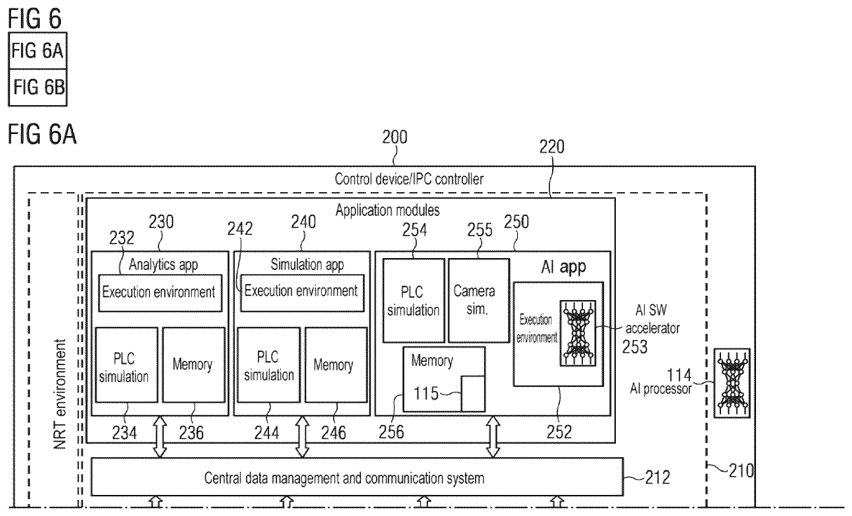

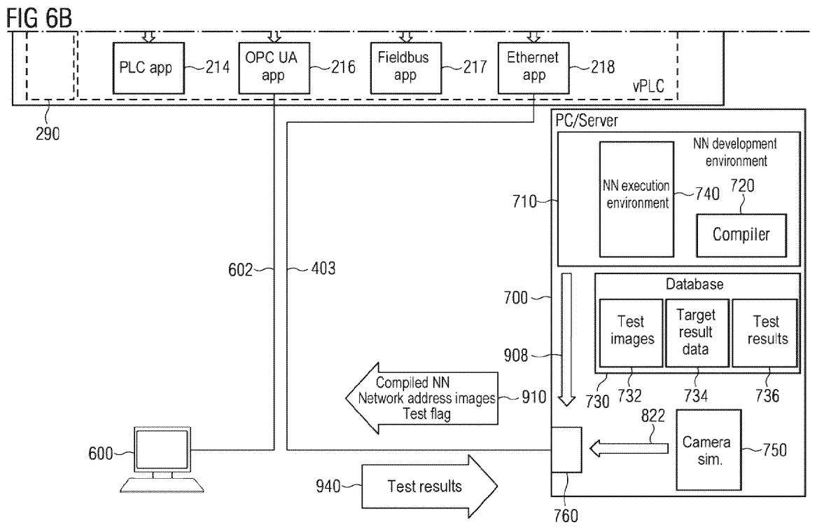

FIG. 6 illustrates a further exemplary embodiment of testing of the compiled neural network 115 in the AI app 250. Here, the compiler 720 of the NN development environment 710 is configured such that the neural network 115 is adapted for execution using the AI processor 114, formed as hardware, of the industrial PC 200.

As such, the AI app 250 is installed in the soft PLC 210 in the manner already illustrated and explained in FIG. 4. However, in the case of the exemplary embodiment illustrated in FIG. 6 for testing the compiled neural network 115 in the AI app 250, the PLC app 214 of the soft PLC 210 does not yet comprise a control program and/or the soft PLC 210 is not yet, or not yet completely, configured for controlling the robot 500 and/or the AOI system with the camera 400 or does not yet control the systems mentioned.

The test sequence illustrated in FIG. 6 for testing the neural network application 115 compiled by the compiler 720 of the NN development environment 710 begins with transfer of the compiled neural network 115 in a first step 908, represented as an arrow in FIG. 6, to the Ethernet interface 760 of the PC 700. At the same time, the address information for the test images 732 and the test flag are also transferred to the Ethernet interface 760. In a next work step 910, once again represented as an arrow in FIG. 6, these pieces of information are then transferred via an Ethernet connection 403 and the Ethernet app 218 of the soft PLC 210 to the AI app 250 of the soft PLC 210 and are stored in the user data memory 256 thereof.

In the context of a restart of the AI app 250, the presence of a test flag in the user data memory 256 of the AI app 250 is then checked. After the test flag transferred in step 910 has been recognized, the AI app 250 is put into the test mode, whereupon the testing of the compiled neural network 115 within the AI app 250 is started. Here, the general sequence of such a test corresponds to the sequence illustrated in association with FIG. 3.

As such, a start of a check of a test image 732 is triggered by the PLC simulation 254. The camera simulation 255 then effects the organization of the test image 732 by a procedure in which, based on the address information for the test images 732, from the PC 700, the camera simulation downloads one or more test images 732 and makes same available as test input data to the compiled neural network 115 executed in the execution environment 252 of the AI app 250. Here, making available the one or more test images in the PC 700 is likewise realized by a camera simulation 750, which then retrieves the one or more test images 732 from the database 730 and transfers same via an Ethernet interface 760 to the AI app 250. The one or more test results 736 then generated by the processing of the one or more test images 732 by the compiled neural network 115 are then stored in the user data memory 256. After the end of the test, in a further method step 940, likewise again represented as an arrow in FIG. 6, these results are transferred to the PC 700 into the database 730 and stored there as test results 736.

Afterward, in the NN development environment 710 of the PC 700, a comparison of the test results 736 with the desired or target results 734 is performed and the result of this comparison is then output to a user.

In the manner illustrated in particular with reference to FIGS. 2, 3, 5 and 6, it is possible to test the NN application 115, for example, in a compiled version specifically adapted for the hardware and/or software of the AI app 250 or of the AI module 110. As explained in the context of the disclosed embodiments, the testing on the AI module 110 or the AI app 250 can occur in this case with direct interaction of the NN development environment 710 or of the PC 700 upon which the NN development environment 710 executes. In particular, testing of the neural network 115 or of the compiled neural network 115 can proceed without, for example, a central module 102 of the PLC 100 or the PLC app 214 of the IPC 200 being required.

In particular, it has been explained how testing of the neural network 115 or of the compiled neural network 115 can occur with the AI module 110 or the AI app 250, without these being connected to the PLC 100 or the IPC 200.

By virtue of the fact that the testing of the neural network 115, or of the compiled neural network 115, occurs directly with interaction of the NN development environment 710 with the AI module 110 or the AI app 250, it is not necessary that the automation engineering system 600 must be used or involved for the purpose of testing. This is advantageous in particular because the development of the neural network 115 can be undertaken, for example, by a specialist in artificial intelligence methods, who then does not need also to have their own knowledge in automation engineering for the testing of the neural network 115 on the AI module 110, or with the AI app 250. This simplifies testing of a user application for a freely programmable application module for a control device.

The methods for testing a neural network explained in the context of FIGS. 1-6 can correspondingly also be applied to the testing of a simulation program in the simulation application 240 or the testing of an analysis program in the analytics application 230. For example, specific starting conditions for a system to be simulated can then be used as test data in the testing of the simulation app 240. For example, corresponding test data can be used for the testing of the analytics application 230.

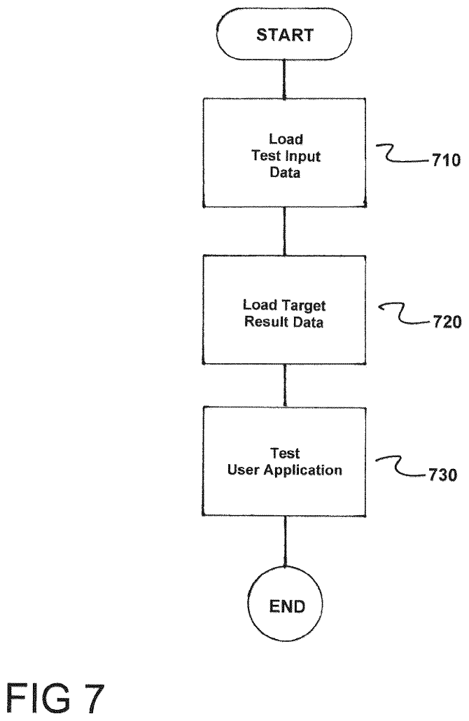

FIG. 7 is a flowchart of the method for testing a user application 115 with the application module 110, 230, 240, 250 for a control device in accordance with an exemplary embodiment.

The method comprises loading test input data 732 for testing a user application 115, as indicated in step 710.

Next, target result data 734 constituting a planned result of processing of the test input data 732 by the user application 115 is loaded, as indicated in step 720.

Next, the user application 115 is tested utilizing the test input data 732 and the target result data 734, as indicated in step 730.

In accordance with the inventive method, the application module 110, 230, 240, 250 is configured to either (i) load the test input data 732, (ii) load the target result data 734 and/or (iii) test the user application 115 without inclusion of the control device 100, 200 and/or the automation engineering system 600.

In accordance with the inventive method, the application module 110, 230, 240, 250 is configured to communicate and interact with further components 102, 104, 114, 214, 216, 217, 218, 230, 240 of the control device 100, 200 in a context of control of a machine 400, 500 or installation.

In addition, the application module 110, 230, 240, 250 is configured to generate additional functionality for the control device 100, 200 via the user application 115.

Furthermore, the application module 110, 230, 240, 250 comprises a control device simulation application 116, 234, 244, 254 for simulating a control functionality of the control device 110, 230, 240, 250, where testing the user application 115 occurs with participation of the control device simulation application 116, 234, 244, 254.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-19. (canceled)

20. An application module for a control device, wherein the application module is configured to communicate and interface with further components of the control device in a context of control of a machine or installation;
wherein the application module is further configured to generate additional functionality for the control device via a user application;
wherein an automation engineering system configures the control device and an application engineering system creates the user application; and
wherein the application module is further configured such that testing of the user application one of occurs and is performable via interaction of the application module with the application engineering system.

21. The application module as claimed in claim 20, wherein the application module is further configured to execute an operating mode;
wherein the user application utilized during the operating mode to generate the additional functionality for the control device;
wherein the application module is further configured to execute a test mode; and
wherein the test mode is configured to test the user application.

22. The application module as claimed in claim 20, wherein the application module comprises a control device simulation application for simulating a control functionality of the control device.

23. An application module for a control device, wherein the application module is configured to communicate and interact with further components of the control device in a context of control of a machine or installation;
wherein the application module is configured to generate additional functionality for the control device via a user application; and
wherein the application module comprises a control device simulation application for simulating a control functionality of the control device.

24. The application module as claimed in claim 23, wherein an automation engineering system configures the control device and an application engineering system creates the user application; and
wherein the application module is further configured such that testing of the user application one of occurs and is performable via interaction of the application module with the application engineering system.

25. The application module as claimed in claim 23, wherein the application module is further configured to execute an operating mode;
wherein the user application is utilized during the operating mode to generate the additional functionality for the control device;
wherein the application module is further configured to execute a test mode; and
wherein the test mode is configured to testing the user application.

26. The application module as claimed in claim 24, wherein the application module is further configured to execute an operating mode;
wherein the user application is utilized during the operating mode to generate the additional functionality for the control device;
wherein the application module is further configured to execute a test mode; and
wherein the test mode is configured to testing the user application.

27. The application module as claimed in claim 23, wherein a test identifier is implemented; wherein the application module is further configured for interrogating and/or recognizing the test identifier and for executing the test mode after recognition of the test identifier, and/or for testing the user application after recognition of the test identifier.

28. The application module as claimed in claim 20, wherein the application module comprises a test storage device or is connected to the test storage device; and wherein the test storage device is writable without inclusion of at least one of the control device and an automation engineering system.

29. The application module as claimed in claim 28, wherein the test storage device is releasably connected to the application module.

30. The application module as claimed in claim 28, wherein the test storage device is writable or is written to via an external communication interface of the application module.

31. The application module as claimed in claim 29, wherein the test storage device is writable or is written to via an external communication interface of the application module.

32. The application module as claimed in claim 28, wherein test data for testing the user application are stored on the test storage device; and wherein the test data constitute at least one of test input data for use by the application module and target result data constituting a predefined result of the processing of the test input data by the application module.

33. The application module as claimed in claim 28, wherein the test storage device comprises at least one of the user application and application configuration data for configuring at least one of the application module and the user application.

34. The application module as claimed in claim 27, wherein the test storage device comprises the test identifier.

35. The application module as claimed in claim 28, wherein the test storage device comprises ID information related to an external storage device; and wherein the application module is configured to at least one of (i) recognize data on the external storage device and (ii) at least one of request and load data from the external storage device.

36. The application module as claimed in claim 35, the application module is configured to at least one of (i) configured to recognize, request and load test data for testing at least one of the user application, application configuration data for configuring the application module, application configuration data for configuring the user application and the test identifier at least one of on and from the external storage device.

37. A method for testing a user application with the application module for a control device, the method comprising:
loading test input data for testing a user application;
loading target result data constituting a planned result of processing of the test input data by the user application; and
testing the user application utilizing the test input data and the target result data;
wherein the application module is configured to at least one of (i) load the test input data, (ii) load the target result data and (iii) test the user application without inclusion of at least one of the control device and an automation engineering system;
wherein the application module is configured to communicate and interact with further components of the control device in a context of control of a machine or installation;
wherein the application module is configured to generate additional functionality for the control device via the user application;
wherein the application module comprises a control device simulation application for simulating a control functionality of the control device; and
wherein testing the user application occurs with participation of the control device simulation application.

38. A method for writing to a test storage device for an application module via an application engineering system, the method comprising:
processing test input data via a user application and storing target result data determined during said processing; and
writing at least one of the test input data and the target result data to the test storage device via an application engineering system.

39. A method for writing to a test storage device for an application module via an application engineering system, the method comprising:
processing test input data via a user application and storing target result data determined in during said processing;
storing at least one of the test input data and the target result data in a storage device which is addressable via ID information; and
writing the ID information to the test storage device via the application engineering system.

40. The method as claimed in claim 38, wherein a test identifier is additionally written to the test storage device.

41. The method as claimed in claim 39, wherein a test identifier is additionally written to the test storage device.

42. The method as claimed in claim 38, wherein the user application is additionally written to the test storage device.
